(19) United States
(12) Patent Application Publication
(10) Pub. No.: US 2008/0186120 A1
(43) Pub. Date: Aug. 7, 2008

(54) Winding Arrangement for Planar Transformer and Inductor

(75) Inventor: Christoph Loef, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,323

(22) PCT Filed: Apr. 28, 2006
(86) PCT No.: PCT/IB2006/051338

§ 371 Date: Nov. 1, 2007

(30) Foreign Application Priority Data
May 3, 2005 (EP) 05103666.3

(51) Int. Cl. H01F 27/28; H01F 17/00

(52) U.S. Cl. 336/180; 336/200

(57) ABSTRACT

Abstract: The invention relates to a winding arrangement (31) for a planar transformer, in particular for high frequency AC transformation, or for an inductor. In order to provide a winding arrangement (31) for a planar transformer or for an inductor which exhibits the advantages of planar winding arrangements and reduces or avoids the skin-effect, a winding arrangement (31) for a planar transformer, in particular for high frequency AC transformation, or for an inductor is proposed including at least two conduction layers (37, 39), each conduction layer (37, 39) having an inner hole (45) and comprising a plurality of conductor paths (19, 27), which are electrically insulated from each other and which lead from an outer circumference (21) of said conduction layer (37, 39) to an inner circumference (23) of said conduction layer (37, 39) adjacent to said inner hole (45) in a spiral form.

The invention relates to a winding arrangement for a planar transformer, in particular for high frequency AC transformation, or for an inductor.

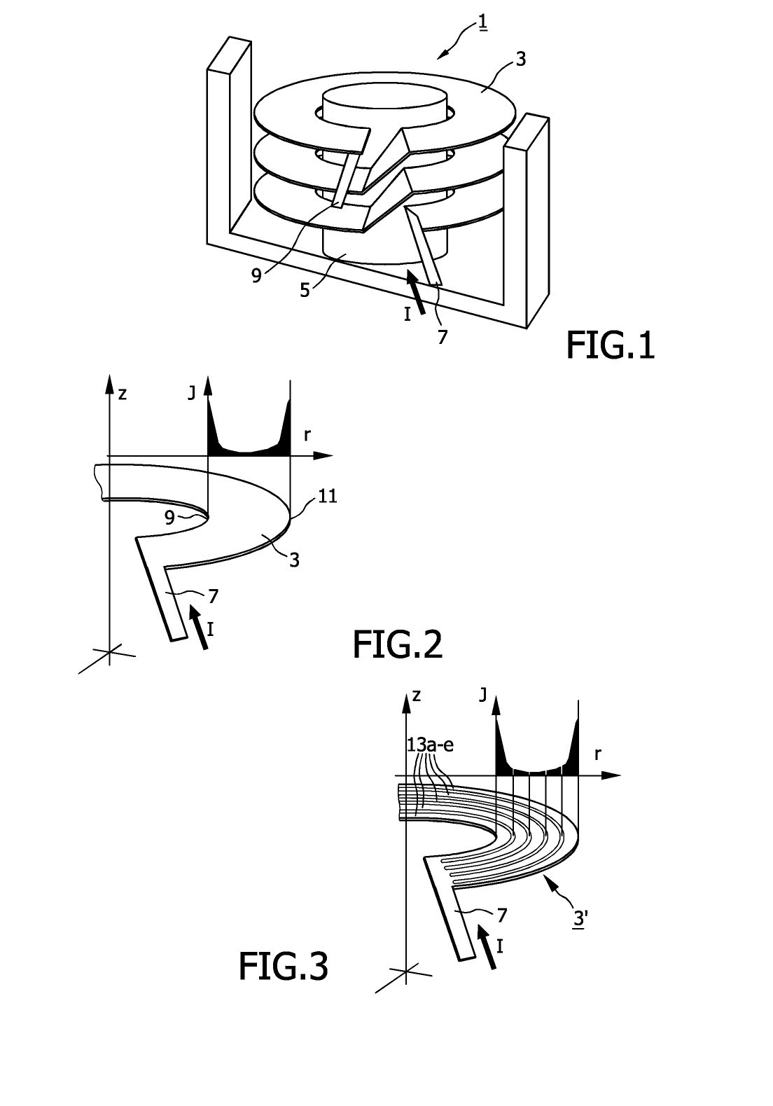

For the purpose of power supply often a voltage has to be transformed to another voltage and the consumer load has be to galvanically isolated from the supplying grid. This is achieved by transformers having a core and primary and secondary windings. Commonly these primary and secondary winding are provided by wire or cord. For some special applications at least one of these windings is formed by a planar winding, e.g. as a conductor strip or foil or a printed circuit board (PCB). An advantage of such an arrangement is a better reproducibility and a reduced capacitance. Planar winding arrangements are known from U.S. Pat. No. 5,166,965, U.S. Pat. No. 5,774,349, U.S. Pat. No. 5,991,178 and WO 93/19515 and are described in “Comparative Study of Flex-Foil Technology in HF Planar Transformers Windings”, P. Zumel et al., IEEE Power Electronics Specialist Conference (PESC), Cairns (Australia), June 2002 and in “Improved PFC Boost Choke using a Quasi-Planar Winding Configuration”, D. Shonts, Proceeding of the 14^{th} IEEE Applied Power Electronics Conference, Dallas, Tex., USA, Mar. 14-18, (1999). An embodiment of a known planar winding arrangement is illustrated in FIG. 1.

A disadvantage common to all known planar winding arrangements results from the so-called “skin-effect”. There is a non-uniform current density along the width of the planar winding path as shown in FIG. 2. This non-uniformity increases with an increasing frequency of the current in the winding leading to undesirable additional power losses.

It is an object of the present invention to provide a winding arrangement for a planar transformer or for an inductor which exhibits the advantages of planar winding arrangements and overcomes the above mentioned drawback by reducing or avoiding the skin-effect, so that a transformation at higher frequencies with a reduced power losses is possible. It is a further object to provide a planar transformer and an inductor comprising such a winding arrangement.

These objects are achieved by a winding arrangement for a planar transformer, in particular for high frequency AC transformation, or for an inductor, including at least two conduction layers, each conduction layer having an inner hole and comprising a plurality of conductor paths, which are electrically insulated from each other and which lead from an outer circumference of said conduction layer to an inner circumference of said conduction layer adjacent to said inner hole in a spiral form and a planar transformer and an inductor comprising said winding arrangement.

Surprisingly, it was found for such an arrangement that the current in each conductor path is the same while the skin-effect in each conductor path is reduced compared to the skin-effect which would be present in one common broad conductor path instead of the spiral shaped conductor paths. The uniformity of the current density is substantially increased even for higher frequencies. Thus, possible power losses are reduced or even avoided.

Said inner hole preventing said conductor paths of one conduction layer from being connected with each other may further be employed for receiving a transformer core or a inductor core.

In an advantageous embodiment of the present invention at least one carrier plate is provided for carrying said conduction layers. The provision of carrying means allows the use of conduction layers and conductor paths which are not able to support themselves, i.e. much smaller and thinner layers and paths. Other carrying means than said carrier plates are also possible. However, said carrier plates have the advantage of supporting the whole structure of said conduction layers. Thus, undesired deformations of said winding arrangements are avoided. If there is no need for a transformer core or a inductor core around which said winding arrangement is to be arranged around, said carrier plate may also be continuous and may be provided with no hole at all.

According to an embodiment of the present invention said conductor paths have substantially identical shapes. By providing substantially identical shapes it is easily ensured that the conductor paths surround substantially identical magnetic fluxes resulting in substantially identical voltages induced to different conductor paths.

In a preferred embodiment said carrier plates are electrically insulating and on each side of said carrier plates a conduction layer is provided, wherein the directions of rotation of the spirals around said inner hole formed by the conductor paths on different sides of a carrier plate are opposite to each other. Two conductor paths, one of the each side of said carrier layer being connected at their, for example, ending points at said inner circumference, result in a path starting at the starting point of one conductor path and ending at the starting point of the other conductor path, wherein said path revolves in one direction of rotation around said inner hole.

In an advantageous embodiment the two conduction layers of each carrier plate have substantially mirrored shapes ensuring substantially induced voltages.

It is further preferred to provide insulation plates between said carrier plates for insulating the conduction layers of adjacent carrier plates from each other. Even if adjacent carrier plates with conduction layers on each side are arranged closely together short circuits are prevented by insulation plates being provided in between the carrier plates.

In another embodiment of the present invention winding arrangement comprises a plurality of winding paths revolving around said inner hole, each winding path comprising a plurality of conductor paths, wherein conductor paths of said plurality of conductor paths are alternately connected at their starting points at said outer circumference and their ending points at said inner circumference, wherein the directions of rotation of the spirals around said inner hole formed by each two connected conductor paths are opposite to each other. A winding path comprises a number of conductor paths of different conduction layers.

For example, said winding path starts at a starting point of a first conductor path at said outer circumference. A second conductor path is connected at its ending point at said inner circumference with the ending point of said first conductor path. Thus, said winding path continues with said second conductor path to the starting point of said second conductor path at said outer circumference. In other words, said winding path includes said first conductor path leading form said outer circumference to said inner circumference and said second conductor paths leading back to said outer circumference. The direction of rotation of said second conductor path is opposite to that of said first conductor path, thus, the course of said winding path follows the revolution of a number of conductor paths around said inner hole.

In yet another embodiment of the present invention the difference of an angle of said starting point of a conductor path at said outer circumference and an angle of an ending point of said conductor path at said inner circumference is a vulgar fraction of 360°, in particular ½, ⅖ or 1/3. A combination of an integer number of conduction layers thus gives a revolution of 360° allowing an easy external connection of said conductor paths. The denominator of said vulgar fraction gives the number of conductor paths needed to achieve a number of revolutions around said inner hole equal to the nominator of said vulgar fraction.

It is further preferred that said starting points of said conductor paths of adjacent conduction layers and/or adjacent carrier plates are rotated by an angle in the range from 0° to 25°, in particular form 5° to 15°, and/or the difference of an angle of a starting point of a conductor path at said outer circumference and an angle of an ending point of said conductor path at said inner circumference differs from 180° or 120° by a value in the range from 0° to 25°, in particular from 5° to 15°. By differences it is achieved that there is a rotational shift between adjacent conduction layers and/or carrier plates resulting in a helix-like combination of conductor paths wherein not only the course of the conductor paths but also a center of symmetry of said course revolves around said inner hole. This allows the winding arrangement and each combination of conductor paths to be symmetric in regard of said inner hole.

It has been found to be advantageous if the number of said plurality of conductor paths on one side of said carrier plate is in the range from 4 to 20, preferably in the range from 6 to 12. This gives a reasonable compromise between the size, i.e. the width, and the number of conductor paths in said conduction layer.

In yet another advantageous embodiment of a winding arrangement according to the present invention N is the number of conductor paths in one conduction layer and adjacent conduction layers are rotated against each other by an angle in the range from 360°/(N+1) to 360°/(N−1). According to this embodiment the ending points of conductor paths which are to be connected are arranged in such a way that a sufficient large area is covered by both conductor paths, i.e. the projections of said conductor paths coincide partially, so that a connection by said two conductor paths can by provided by suitable connection means, for instance, by a bolt extending through both conductor paths or by an accordingly defined conductive part of said carrier plate.

According to a preferred embodiment said carrier plate is a printed circuit board. Techniques for producing printed circuit boards with predetermined shapes of conductor paths are well known and thus it is possible to produce winding arrangements according to the present invention in an easy and inexpensive way.

Further, planar transformers according to the present invention, in particular comprising a winding arrangement as claimed in claim 6, are proposed, wherein said winding paths are connected in parallel when said winding arrangement is provided as a primary winding and/or wherein said winding paths are connected in series when said winding arrangement is provided as a secondary winding. Said winding paths connected in parallel result in fewer windings compared to a connection in series.

In the following the present invention is described further in detail with reference to the accompanying figures, in which:

FIG. 1 shows a schematic perspective view of a known winding arrangement for a planar transformer or inductor;

FIG. 2 shows a partial winding of the known winding arrangement shown in FIG. 1 and a related current density distribution;

FIG. 3 shows a partial winding of another winding arrangement and a related current density distribution;

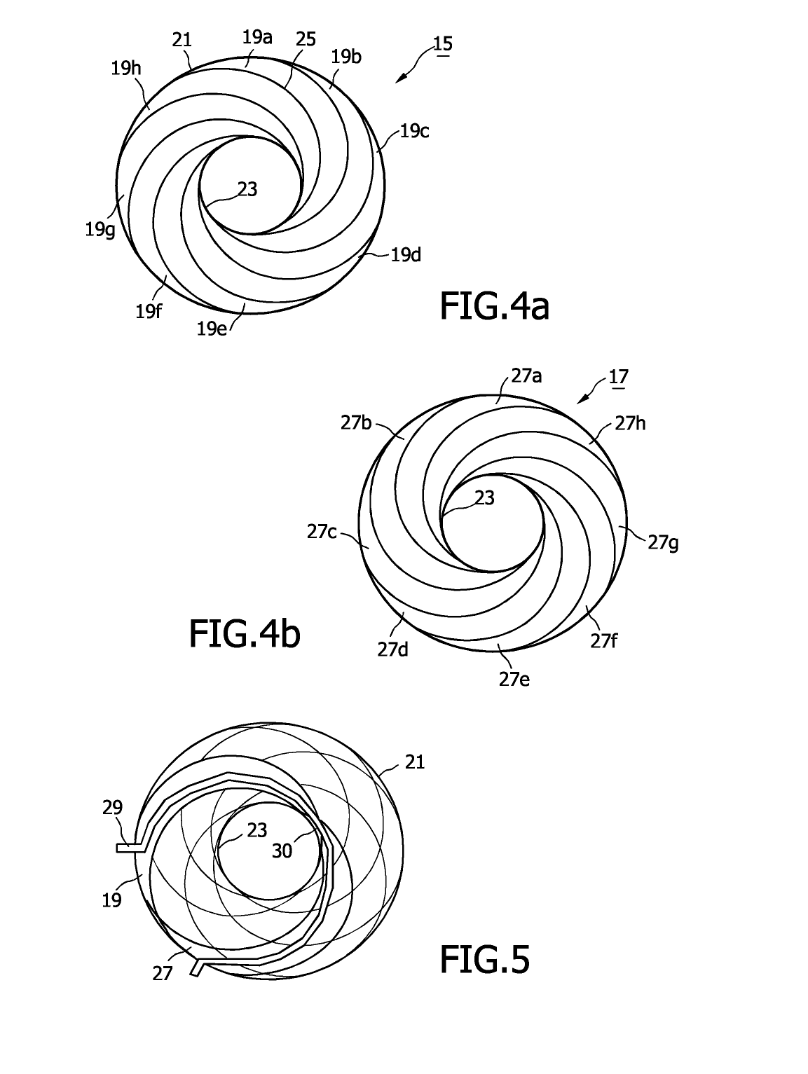

FIG. 4a shows a first layout of a conduction layer according to the present invention;

FIG. 4b shows a second layout of a conduction layer according to the present invention;

FIG. 5 shows a course of two conductor paths according to said first and said second layout shown in FIGS. 4a, 4b being connected at their ending points;

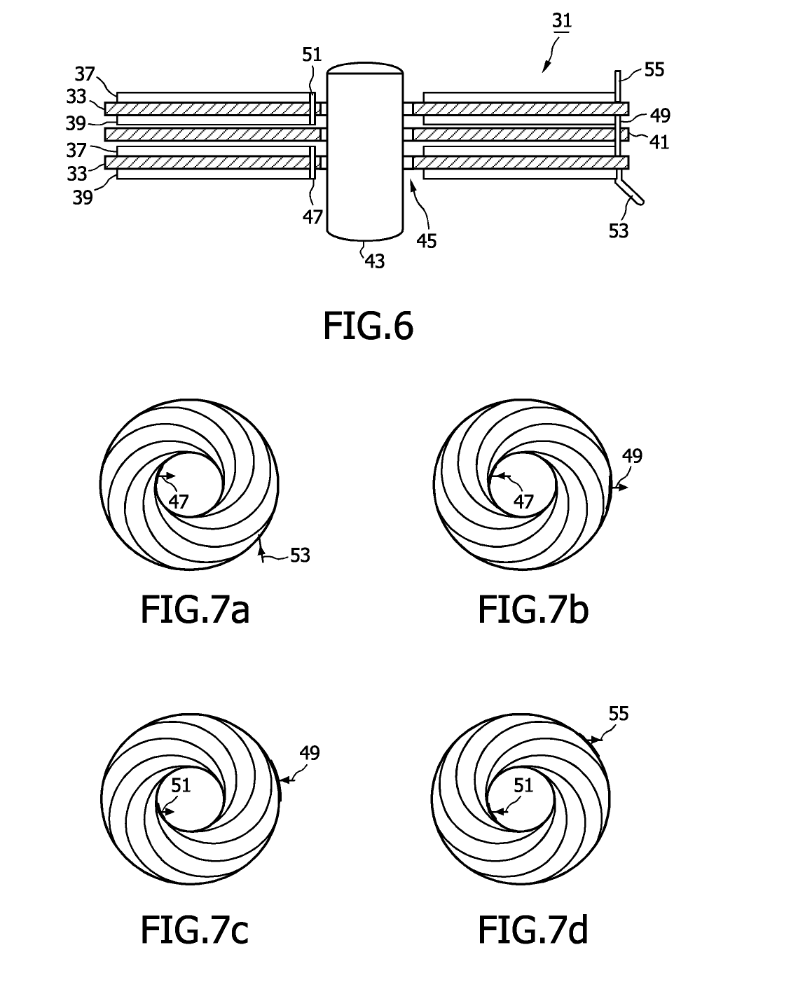

FIG. 6 shows a schematic sectional view of a winding arrangement according to the present invention;

FIGS. 7a-7d illustrate a winding path of the winding arrangement shown in FIG. 6;

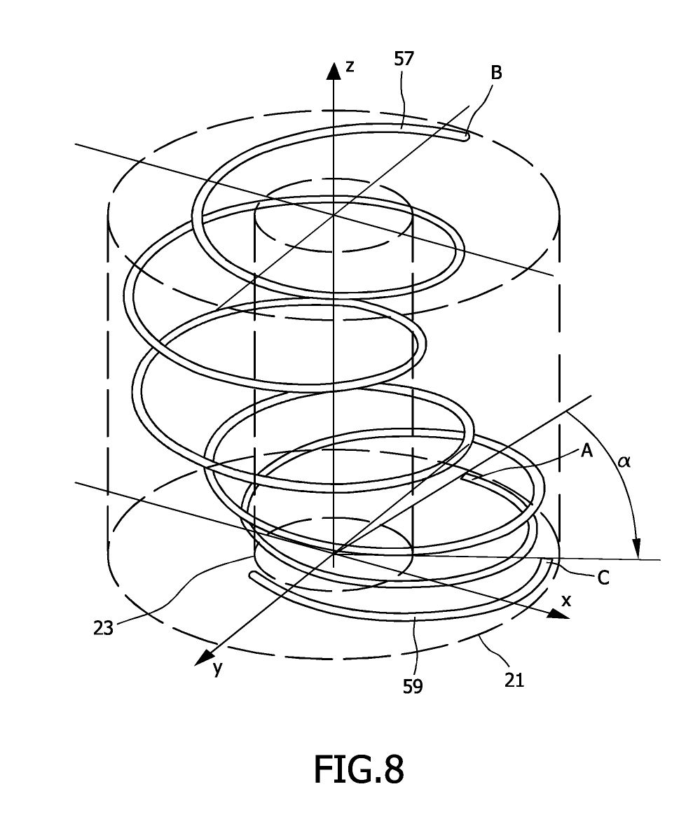

FIG. 8 shows a schematic perspective view of a course of a winding path according to the present invention;

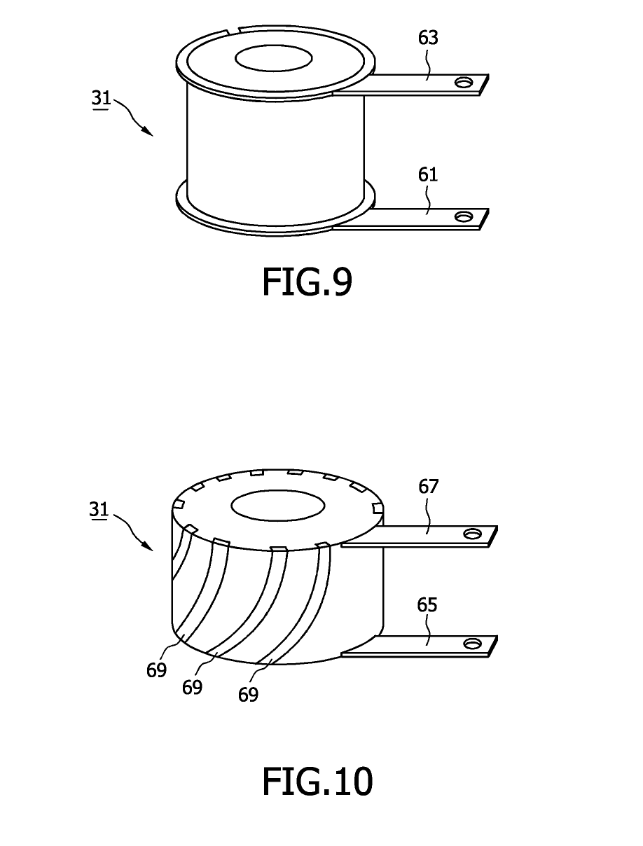

FIG. 9 shows a schematic perspective view of a winding arrangement according to the present invention having winding paths connected in parallel and

FIG. 10 shows a schematic perspective view of a winding arrangement according to the present invention having winding paths connected in series.

FIG. 1 shows a schematic perspective view of a known winding arrangement 1 for a planar transformer or inductor. The winding arrangement 1 comprises three windings of a planar conductor 3 revolving around an inner core 5. The planar conductor 3 is provided with two terminals 7, 9 for feeding or collecting a current I flowing through said planar conductor 3. With said winding arrangement 1 being part of a transformer (not shown) a voltage may be induced into said planar conductor 5 in a common way resulting in a current I. This current flowing through the planar conductor 3 will exhibit a current density distribution as shown in FIG. 2. The current density J is comparatively higher at the inner and outer circumference 9, 11 of the planar conductor 3 than at its inner region due to the so-called skin-effect. The skin-effect increases with an increasing frequency of the current and voltage leading to unwanted additional power losses. The provision of a number of separate partial planar conductors 13a-e forming together a planar conductor 3′ as illustrated in FIG. 3 gives substantially the same current density distribution and is therefore no improvement compared to the continuous planar conductor shown in FIGS. 1 and 2.

FIGS. 4a and 4b show a first and a second layout 15, 17 of a conduction layer of a winding arrangement according to the present invention. Said first and second layout 15, 17 are mirror image-like. Thus, only said first layout 15 is described here in detail since a corresponding description applies to said second layout 17. A conduction layer according to said layout 15 comprises 8 separate conductor paths 19a-h having identical shapes. Said conductor paths 19a-h start at an outer circumference 21 of said conduction layer and coil up clockwise to their ending points at the inner circumference 23. Said inner circumference may surround an inner hole for receiving a transformer core. The course of a conductor path 19a-h follows a spiral forming around one half of a turn around said inner circumference 23. The conductor paths 19a-h are separated by insulating regions 25 which also follow said spiral.

FIG. 5 shows by example a course 29 of two conductor paths 19, 27 according to said first and said second layout 15, 17 shown in FIGS. 4a, 4b being connected at their ending points. Two different conduction layers comprise said first and said second layout 15, 17 and are aligned with each other. Said conduction layers may be arranged on different sides of a carrier plate. Conductor path 19 starts at said outer circumference 21, winds around the inner circumference 23 and ends at a position approximately opposite to its starting point at said inner circumference 23. Conductor path 27 also starts at said outer circumference 21, winds around the inner circumference 23 and ends at a position approximately opposite to its starting point at said inner circumference 23, wherein the ending points of said conductor paths 19, 27 approximately coincide. Said course 29 from the starting point of said conductor path 19 to its ending point at said inner circumference 23 to the ending point of said conductor path 27 to the starting point of said conductor path 27 thus forms a partial revolution around said inner circumference 23. Said conductor paths 19, 27 coincide in an connection area 30 of said layouts adjacent to said inner circumference. A conductive bolt (not shown) projecting through both conductor paths 19, 27 forms a connection between them.

FIG. 6 shows a schematic sectional view of a winding arrangement 31 according to the present invention. Said winding arrangement comprises two identical and aligned carrier plates 33 each having two conduction layers 37, 39 arranged on each side of said carrier plates 33. The upper conduction layer 37 has said layout 15 as shown in FIG. 4a and the lower conduction layer 39 has said layout 17 as shown in FIG. 4b. Between said carrier plates 33 an insulation plate 41 is provided for insulating the lower conduction layer 39 of the upper carrier plate 33 and the upper conduction layer 37 of the lower carrier plate 33. Further, a core 43 is arranged inside the inner holes 45 of said carrier plates 33 and said insulation plate 41. A number of connections 47, 49, 51 are provided between conductor paths of adjacent conduction layers 37, 39 forming a winding path. For clarity's sake only the connections of one winding path are shown in FIG. 6 and FIGS. 7a-7d. Said winding path is provided with two terminal points 53, 55.

The course of said winding path of said winding arrangement shown in FIG. 6 is illustrated in FIGS. 7a-7d. The winding path starts at said terminal point 53 at said lower conduction layer 39 of said lower carrier plate 33, winds around said core 43 (FIG. 7a), follows said connection 47 between said lower conduction layer 39 and said upper conduction layer 37 of said lower carrier plate 33 (FIGS. 7a, 7b), winds around said core 43 (FIG. 7b), follows said connection 49 between said upper conduction layer 37 of said lower carrier plate 33 and said lower conduction layer 39 of said upper carrier plate 33 (FIGS. 7b, 7c), winds around said core 43 (FIG. 7c), follows said connection 51 between said lower conduction layer 39 and said upper conduction layer 37 of said upper carrier plate 33 (FIGS. 7c, 7d), winds around said core 43 (FIG. 7d) and ends at said terminal point 55.

FIG. 8 shows a schematic perspective view of a course of a winding path 57 according to the present invention. In order to improve clarity said winding path 57 is shown as a continuous path wherein indications of said conduction layers and said connections are omitted. Said winding path 57 starts at point A at said outer circumference 21, revolves around said inner circumference 23 and ends at point B said at said outer circumference 21. The center of revolution of said winding path 57 around said inner circumference 23 also revolves around said inner circumference 23. Said winding path 57 thus forms a helix which is winded around said inner circumference 23. A part of a second winding path 59 is shown starting form point C. Said second winding path 59 corresponds to said first winding path 57 while being rotated with an angle a against said first winding path 57. Effects of the winded helix are a symmetry of the resulting magnetic field around said inner circumference 23 and a symmetry of the induced voltages/currents.

A winding arrangement 31 according to the present invention comprising conduction layers according to the layouts shown in FIG. 4a, 4b comprises 8 winding paths 57. FIG. 9 shows a schematic perspective view of a winding arrangement 31 having winding paths 57 connected in parallel. The ends of said winding paths 37 are connected to respective common terminals 61, 63, wherein said terminal 61, 63 are interrupted in order to avoid short circuits within said terminals. FIG. 10 shows a schematic perspective view of a winding arrangement 31 having winding paths 57 connected in series. A first terminal 65 is provided at the starting point of a first winding path 57. Said winding path 57 is connected at its ending point to a starting point of another winding path 57 by a connection 69 and so on. The last winding path 57 is provided with a second terminal 67.

In the embodiments illustrated in the figures the starting points of said paths and the terminals are provided at said outer circumference. However, it has to be noted that terminals, connections and the like may also be provided at said inner circumference and at both inner and outer circumference. Further, it is possible to connect said conduction layers and conductor paths in different ways. The invention is not limited to connections between directly adjacent conductor paths or conduction layers. Also, the carrier plates may be stacked in different ways. The invention is also not limited to circular core arrangements since other forms are possible as well. Further, the connection of winding paths in series and in parallel may be combined.

A possible method for manufacturing a winding arrangement according to the present invention is to provide printed circuit boards on both sides with said conduction layers and to stack said printed circuit boards with insulation plates in between. Another possible method is to start with a single printed circuit board, to arrange an insulation or spacing layer on top of one side of it and to provide on top of said insulation or spacing layer another conduction layer and so on, by turns. An easy way to connect conductor paths of different conduction layers is to put an electroconductive bolt through them and their separating layers.

The present invention is not limited to a winding arrangement comprising carrier plates for carrying said conduction layers. Said conduction layers and conductor paths may also be constructed in such a way that they are mechanically strong enough to carry themselves without need for a further support. Suitable carrying means may also be provided in form of carrying rods, for example. Another possibility is to embed said conduction layers in a resin of some other suitable material for supporting said conduction layers.

By way of example the present invention is described having conductor paths with a decreasing width from said outer circumference to said inner circumference being separated by insulation areas with a constant width. However, it is also possible to provide conductor paths with substantially constant width wherein the width of said insulation areas is changing. It is further possible to provide a combination of these general layouts or other similar layouts.

By means of a suitable spatial arrangement of conductor paths or winding paths in a magnetic field (cf. FIG. 8) it is possible to achieve substantially identical induced voltages U_{ab}=∫ B dA₁ in each conductor path or winding path ensuring a substantially identical currents in each conductor path or winding path. With the conductor paths or winding paths having substantially identical geometries (at least in a projection along a center line) relative to the center line, the magnetic flux comprised by each conductor path or winding path is the same. Thus, the currents and current densities in the conductor paths or winding paths are the same. To ensure equal current densities for a current-fed winding arrangement the winding paths may be fed by sources providing the same current.

According to the present invention a winding arrangement is proposed which avoids or reduces the “skin-effect” so that the winding arrangement may be used with higher frequencies and lower power losses. Such a winding arrangement may, for instance, be used in applications in which a planar, printed circuit board winding is utilized and a high frequency is used like high voltage transformers for X-ray tubes.

1. Winding arrangements for a planar transformer, in particular for high frequency AC transformation, or for an inductor, including at least two conduction layers, each conduction layer having an inner hole and comprising a plurality of conductor paths, which are electrically insulated from each other and which lead from an outer circumferences of said conduction layer to an inner circumferences of said conduction layer adjacent to said inner hole in a spiral form.

2. Winding arrangement as claimed in claim 1,
wherein at least one carrier plate is provided for carrying said conduction layers.

3. Winding arrangement as claimed in claim 1,
wherein said conductor paths have substantially identical shapes.

4. Winding arrangement as claimed in claim 2,
wherein said carrier plates are electrically insulating and on each side of said carrier plates a conduction layer is provided, wherein the directions of rotation of the spirals around said inner hole formed by the conductor paths on different sides of a carrier plate are opposite to each other.

5. Winding arrangement as claimed in claim 4,
wherein the two conduction layers of each carrier plate have substantially mirrored shapes.

6. Winding arrangements as claimed in claim 4,
wherein insulation plates are provided between said carrier plates for insulating the conduction layers of adjacent carrier plates from each other.

7. Winding arrangements as claimed in claim 1,
comprising a plurality of winding paths revolving around said inner hole starting and ending at said inner or outer circumference, each winding path comprising a plurality of conductor paths, wherein conductor paths of said plurality of conductor paths are alternately connected at their starting points at said outer circumference and their ending points at said inner circumference, wherein the directions of rotation of the spirals around said inner hole formed by each two connected conductor paths are opposite to each other.

8. Winding arrangement as claimed in claim 1,
wherein the difference of an angle of said starting point of a conductor path at said outer circumference and an angle of an ending point of said conductor path at said inner circumference is a vulgar fraction of 360°, in particular ½, ⅖ or ⅓.

9. Winding arrangement as claimed in claim 1,
wherein said starting points of said conductor paths of adjacent conduction layers and/or adjacent carrier plates are rotated by an angle in the range from 0° to 25°, in particular form 5° to 15°.

10. Winding arrangements as claimed in claim 1,
wherein the difference of an angle of a starting point of a conductor path at said outer circumference and an angle of an ending point of said conductor path at said inner circumference differs from 180° or 120° by a value in the range from 0° to 25°, in particular from 5° to 15°.

11. Winding arrangement as claimed in claim 1,
wherein the number of said plurality of conductor paths in one conduction layer is in the range from 4 to 20, preferably in the range from 6 to 12.

12. Winding arrangement as claimed in claim 1,
wherein N is the number of conductor paths in one conduction layer and adjacent conduction layers are rotated against each other by an angle in the range from 360°/(N+1) to 360°/(N−1).

13. Winding arrangement as claimed in claim 2,
wherein said carrier plate is a printed circuit board.

14. Planar transformer, in particular for high frequency AC transformation, comprising a transformer core and a first and a second winding arrangement provided around said transformer core, at least one of said winding arrangements being a winding arrangement according to claim 1.

15. Planar transformer in particular for high frequency AC transformation, comprising a transformer core and a first and a second winding arrangement provided around said transformer core, at least one of said winding arrangements being a winding arrangement for a planar transformer, in particular for high frequency AC transformation, or for an inductor, including at least two conduction layers, each conduction layer having an inner hole and comprising a plurality of conductor paths, which are electrically insulated from each other and which lead from an outer circumference of said conduction layer to an inner circumference of said conduction layer adjacent to said inner hole in a spiral form, in particular comprising a winding arrangement as claimed in claim 6 as a primary winding, wherein said winding paths are connected in parallel.

16. Planar transformer, in particular for high frequency AC transformation, comprising a transformer core and a first and a second winding arrangement provided around said transformer core, at least one of said winding arrangements being a winding arrangement for a planar transformer, in particular for high frequency AC transformation, or for an inductor, including at least two conduction layers, each conduction layer having an inner hole and comprising a plurality of conductor paths, which are electrically insulated from each other and which lead from an outer circumference of said conduction layer to an inner circumference of said conduction layer adjacent to said inner hole in a spiral form, in particular comprising a winding arrangement as claimed in claim 6 as a secondary winding, wherein said winding paths are connected in series.

17. Inductor comprising a winding arrangement as claimed in claim 1.
